(19) United States
(12) Patent Application Publication
(10) Pub. No.: US 2013/0244002 A1
(43) Pub. Date: Sep. 19, 2013

(54) MARKED SOLID PHARMACEUTICAL FORM, AND METHOD FOR THE PRODUCTION THEREOF BY MEANS OF LASER MARKING

(71) Applicant: SANOFI, Paris (FR)

(72) Inventors: Sebastien DASSIE, Villenave d'Ornon (FR); Laurence PEIRET, Ambares (FR)

(73) Assignee: SANOFI, Paris (FR)

(21) Appl. No.: 13/875,762

(22) Filed: May 2, 2013

Related U.S. Application Data
(63) Continuation of application No. PCT/FR2011/052565, filed on Nov. 3, 2011.

(30) Foreign Application Priority Data
Nov. 3, 2010 (FR) 1059063

(51) Int. Cl. A61J 3/00

(52) U.S. Cl. CPC A61J 3/007
USPC 428/141; 264/400; 428/156

(57) ABSTRACT

The invention relates to a marked solid pharmaceutical form including a continuous groove on the surface thereof, said groove preferably being 20 μm to 50 μm deep and preferably 5 μm to 120 μm wide. The invention also relates to a method for marking such a pharmaceutical form by forming at least one groove therein by means of laser ablation of the surface of the solid form, said method being such that the laser ablation is carried out with laser energy of 0.1 to 500 mJ/mm²

### FIELD OF THE INVENTION

The invention relates to a marked solid pharmaceutical form, and a laser marking method making it possible to produce this form. Such a laser marking is invisible to the naked eye, but can be revealed by optical microscopy. It is an effective means in the fight against counterfeiting.

Hereinafter, the word “marking” will designate both the marking itself and the “marking method”.

### BACKGROUND OF THE INVENTION

The fight against counterfeiting is a major problem in the pharmaceutical industry. Indeed, counterfeiting is the biggest type of fraud observed in this industry.

The counterfeiters imperil the safety of the patient, who may be treated with a product that includes no active principle and therefore has no beneficial effect. At worst, the patient may be treated with a product having damaging effects.

In all these cases of pharmaceutical product fraud, the detection of the suspect products is essential. The suspect product can be authenticated for example by analysis of the composition of the product, but such an analysis is slow and costly. Furthermore, an authentic product may come from different sources, which complicates this detection.

Numerous methods for fighting against counterfeiting have been considered in the prior art. Thus, printing methods, for example on the packages or “blisters” (or “blister packs”), or characterization methods such as bar codes, do exist. However, from the many solutions for which investigations have been carried out, no consensus in the fight against counterfeiting emerges because none of these solutions fulfils all the criteria of cost, effectiveness, and ease of implementation, both in the characterization and in the detection.

The use of laser has been considered in the context of this fight against counterfeiting in the pharmaceutical industry in particular for producing marking patterns on the surfaces of the products or medical devices made of glass or of plastic materials, most commonly polymer(s).

In this context, the laser marking of pharmaceutical tablets is described in the document WO 2009/051794. The latter discloses a tablet on the surface of which is formed a network. This network is intended to be revealed subsequently by moiré effect, when a revealing layer is overlaid on it. The network is produced by ablation of a part of the surface which can be performed by laser. The dimensions of the network are of the order of a micrometer, and in particular the depth of the ablation is between 50 nm and 5 micrometers (μm).

In the context of the pharmaceutical industry, there is therefore still a need to have solid pharmaceutical forms of which each unit has a discreet means of anti-counterfeiting recognition.

The invention advantageously makes it possible to provide an effective solution in the fight against counterfeiting, and to overcome the drawbacks of the methods and devices of the prior art. In particular, the invention makes it possible to propose a solution for fighting against counterfeiting which meets the needs of the pharmaceutical industry in terms of cost, effectiveness, and ease of implementation, both in the characterization and in the detection.

### SUMMARY OF THE INVENTION

To this end, one of the subjects of the invention is a marked solid pharmaceutical form comprising at least one continuous groove marking its surface, said groove having a depth lying within a range from 10 μm to 100 μm, preferably from 20 μm to 50 μm.

According to a preferred embodiment of the invention, the groove also has a width lying within a range from 5 μm to 120 μm, preferably from 10 μm to 100 μ.

Preferably, the groove forms a closed continuous line.

The groove preferably has a length lying within a range from 250 μm to 3 mm, preferably from 250 μm to 500 μm.

According to a variant of the invention, the surface of the pharmaceutical form has an average roughness depth lying within a range from 10 μm to 40 μm, preferably from 20 μm to 40 μm.

According to one embodiment, the pharmaceutical form most commonly comprises at least two grooves each forming a closed continuous line.

According to another embodiment, independent or not of the previous embodiment, the pharmaceutical form comprises at least two grooves, each groove being separated from another groove by a distance of no more than 100 μm.

Preferably, the groove forms a marking pattern that is invisible to the naked eye, and not perceptible to the touch.

According to a variant, the groove is inscribed in a square with a side lying within a range from 100 μm to 250 μm, preferably from 200 μm to 250 μm. The pharmaceutical form according to the invention is, preferably, chosen from the group formed by sticks, tablets, capsules, chewing gums and granules, preferably chosen from the group formed by tablets.

The invention also relates to a method for marking at least one solid pharmaceutical form according to the invention, said method comprising the formation of at least one groove by ablation of the surface of the solid form by means of a laser ray, said method being such that the laser ablation is performed with a laser energy lying within a range from 0.1 mJ/mm² to 500 mJ/mm², preferably within a range from 0.1 mJ/mm² to 250 mJ/mm².

Preferably, the marking method comprises the supply of a laser ray source, the supply of optical guiding means for guiding the laser ray to the surface of the form, the supply of relative displacement means between the form and the laser ray, and the production of a continuous groove on the surface of the form by means of laser ablation by the laser ray and by means of the relative displacement of the surface and of the laser ray.

The optical guiding means preferably comprise a focusing lens, with a focal length even more preferably chosen from the group formed by 50 mm, 60 mm and 100 mm.

Most commonly, the laser ray has a pulse duration of 100 fs to 50 ns and pulse energy of 0.1 μJ to 100 μJ.

According to the invention, an infrared laser can be used with a pulse duration of 100 to 1000 fs, pulse energy of 0.1 μJ to 100 μJ, preferably of 0.1 μJ to 30 μJ, and wavelength lying within a range from 1000 to 1,000,000 nanometers. For example, a laser is used with a wavelength of 1030 nm.

According to the invention, it is possible to use an ultraviolet laser with a pulse duration of 5 to 50 ns, pulse energy of 1 to 100 μJ, preferably 3 μJ to 100 μJ, and wavelength lying within a range from 10 to 380 nanometers. For example, a laser is used with a wavelength of 266 nm.

Most commonly, the laser guiding means comprise at least one means for separating the laser ray into a number of secondary rays so as to form, preferably simultaneously, a number of continuous grooves on the surface of the pharmaceutical form.

The invention finally relates to a packaging article comprising at least one pharmaceutical form according to the invention.

### BRIEF DESCRIPTION OF THE FIGURES

FIG. 1 schematically represents an optical system forming part of a laser marking device according to the invention, and

FIG. 2 schematically represents the laser marking device according to the invention comprising the optical system of FIG. 1.

### DETAILED DESCRIPTION

The pharmaceutical form is marked (or etched) with the groove (or incision). The depth of the groove can be measured by atomic force microscopy, but such a measurement is difficult to perform. Thus, in the context of the invention, it has been deemed preferable, and simpler, to adopt a comparative measurement technique. As it happens, the depth of the groove according to the invention is such that the groove does not pass through a film coating (or coating) of the pharmaceutical form. Therefore, the groove depth measurement can be performed by marking, according to a given parameterization, of a film-coated tablet, with given film coating, typically with a thickness of 50 μm or 100 μm. If the film coating has not been passed through by the marking, the groove depth is in one of the ranges according to the invention. The duly parameterized marking can then be used on an uncoated tablet or on a film-coated tablet.

The width of the groove can be measured by scanning electron microscopy, the measurement accuracy generally being +or −5%. When the marking is produced by laser ablation, the characteristics of the laser beam and the marking conditions enable those skilled in the art, if it is thought necessary, to establish a link between the width of the groove and the depth of the groove.

The term “pharmaceutical form” (or “medicinal form” or “galenic form”) is used, according to the invention, to mean any form containing at least one active principle and at least one excipient (inactive substance) to form a medication. A medication is a substance used to prevent and/or treat, generally treat, an illness. This pharmaceutical form generally corresponds to the final physical aspect of the medication as it will be used by a patient. A pharmaceutical form is “solid” according to the invention if it is limited by stable surfaces.

A groove that is “continuous”, according to the invention, is understood to be a groove produced point by point, the points being sufficiently close together to give, in observation at the groove level, the impression of a continuous groove. Each point is generally the result of a laser ablation by a laser ray pulse. This advantageously makes it possible, in the context of the invention, to obtain the sharpness of the pattern created by the continuous groove or grooves. It would be possible to define the “continuous” groove by a maximum tolerance on the depth differences of the groove: e.g. depth deviation of 5 to 20%, preferably of 5 to 15%, over the entire length of the groove.

Advantageously, the pharmaceutical form of the invention is such that the dissolution profiles of the unmarked pharmaceutical form and of the marked pharmaceutical form are almost identical. Because of this, the dissolution profiles of a marked tablet are not modified compared to the dissolution profile of the unmarked tablet because of the marking operation.

According to a preferred embodiment of the invention, the pharmaceutical form according to the invention is such that the groove forms a marking pattern that is invisible to the naked eye, and not perceptible to the touch. The expression “invisible to the naked eye”, according to the invention, is understood to mean not perceptible to human vision without technical aid. This technical aid is typically a microscope. Generally, an object whose greatest dimension is less than approximately 100 μm is considered to be invisible to the naked eye. Because of this, this marking makes it possible to distinguish said pharmaceutical form from counterfeit products by virtue of the use of an optical microscope, generally under an enlargement of 20 or 100. This makes it possible to have a pharmaceutical form that is specially suited to the fight against counterfeiting.

Generally, the groove is inscribed in a square with a side lying within a range from 100 μm to 250 μm, preferably from 200 μm to 250 μm. Those skilled in the art can produce the marking pattern in such a way that the marking remains invisible to the naked eye, and not perceptible to the touch, for example by taking into account the width of the groove and the size of the square in which the pattern is inscribed.

The groove is generally situated on a part of the outer surface of the pharmaceutical form, this part being accessible and, in particular, visible. The location, on the surface of the tablet, of this part generally depends on the packaging in which said form may be present. Thus, in the commonest case of a tablet that is substantially cylindrical and of low height, the groove is preferably present on one of the surfaces of substantially circular form, and not on the edge of this tablet.

It is also possible to envisage marking the pharmaceutical form with a marking pattern that is visible to the naked eye which makes it possible to identify the point where the groove invisible to the naked eye is located, according to one or more particular criteria. This may allow the customs officer easier access to the groove, by optical microscopy, according to the criterion or criteria which will have been supplied by the manufacturer of the pharmaceutical form.

The dimensions of the groove according to the invention imply that the marking pattern produced by the groove is advantageously sharp and precise. In particular, the pharmaceutical forms of the invention generally exhibit a marking quality such that the marking pattern is not masked by the roughness of the surface of said form. Furthermore, the marking pattern has a particularly long life.

The groove preferably forms a closed continuous line. The length of the groove lies, preferably, within a range from 250 μm to 3 mm, preferably from 250 μm to 500 μm. Because of the possibility of producing a groove with a very small width, those skilled in the art can produce, within these length bands, a groove that is invisible to the naked eye, even with a length of a few tenths to a few millimeters.

Most commonly, the surface of the pharmaceutical form has an average roughness depth lying within a range from 10 μm to 40 μm, preferably from 20 μm to 40 μm.

Advantageously, the pharmaceutical form according to the invention may include a continuous groove such that it is visible, in the conditions indicated previously, even when the surface of the pharmaceutical form is very rough, i.e. has an average roughness depth of approximately 40 μm.

The average roughness depth (Rt) or average height of the roughness profile (Rz) is as defined in the standard ISO 4287:1998. Rt corresponds to the arithmetic mean of the individual profile heights over the length of evaluation. Rz corresponds to the individual profile height which is, for a basic length, the difference between the highest peak and the deepest hollow. According to the invention, five basic lengths for each evaluation length are considered.

According to a variant of the invention, the pharmaceutical form comprises at least two grooves each forming a closed continuous line.

According to another variant of the invention, independent or not of the preceding variant, the pharmaceutical form comprises at least two grooves, each groove being separated from another groove by a distance of no more than 100 μm, for example lying within a range from 10 μm to 80 μm. Such a distance is the shortest distance separating any point of a groove from any other point of another groove.

The pharmaceutical form is generally chosen from the group formed by sticks, tablets, capsules, chewing gums and granules, preferably chosen from the group formed by tablets.

The term “tablets” is used according to the invention to mean tablets that are coated (or film-coated) or not, effervescent or not, enteric-coated or not, immediate- or prolonged- (or modified-) release, to be swallowed or used in the oral cavity, where appropriate soluble or dispersible, orodispersible tablets or oral lyophilizates. The term “capsules” is used according to the invention to mean capsules that are soft shell or hard shell capsules (hard gelatin capsules), immediate- or prolonged- (or modified-) release, enteric-coated or not, as well as the cachets.

The pattern of the marking on the pharmaceutical form according to the invention is, for example, an anti-counterfeiting logo, a text, or any form that the marking tool can produce.

The invention also relates to a method for marking at least one solid pharmaceutical form according to the invention, said method comprising the formation of at least one groove by ablation of the surface of the solid form by means of a laser ray, said method being such that the laser ablation is performed with a laser energy lying within a range from 0.1 mJ/mm² to 500 mJ/mm², preferably within a range from 0.1 mJ/mm² to 250 mJ/mm².

The marking method according to the invention has a high accuracy since it makes it possible to produce the pharmaceutical forms according to the invention by marking them with any pattern of anti-counterfeiting type such as a logo. This marking method also has a great sharpness since the grooves of these marked pharmaceutical forms are visible in optical microscopy, from an enlargement of 20.

Such a marking method advantageously makes it possible to produce a marked pharmaceutical form according to the invention, the groove(s) being invisible to the naked eye and not perceptible to the touch, without modifying the pharmacological properties of said form.

According to a variant, the marking method comprises the supply of a laser ray source, the supply of optical guiding means for guiding the laser ray to the surface of the form, the supply of relative displacement means between the form and the laser ray, and the production of a continuous groove on the surface of the form by means of laser ablation by the laser ray and by means of relative displacement of the surface and of the laser ray.

Generally, the optical guiding means comprise a focusing lens, with a focal length preferably chosen from the group formed by 50 mm, 60 mm and 100 mm.

Most commonly, the laser ray (or beam) has a pulse duration of 100 fs to 50 ns and pulse energy of 0.1 to 100 μJ.

In a first embodiment, the method is such that an infrared laser is used with a pulse duration of 100 to 1000 fs, pulse energy of 0.1 to 100 μJ, preferably of 0.1 μJ to 30 μJ, and wavelength lying within a range from 1000 to 1,000,000 nanometers. In such a case, preferably, the laser has a wavelength of 1030 nm.

In a second embodiment, the method is such that an ultraviolet laser is used with a pulse duration of 5 to 50 ns, pulse energy of 1 to 100 μJ, preferably 3 μJ to 100 μJ, and wavelength lying within a range from 10 to 380 nanometers. In such a case, preferably, the laser has a wavelength of 266 nm.

According to a variant, the laser guiding means comprise at least one means for separating the laser ray into a number of secondary rays so as to form a number of continuous grooves on the surface of the solid pharmaceutical form. Preferably, the formation of the multiple grooves is performed simultaneously.

“A number”, according to the invention, should be understood to mean at least two.

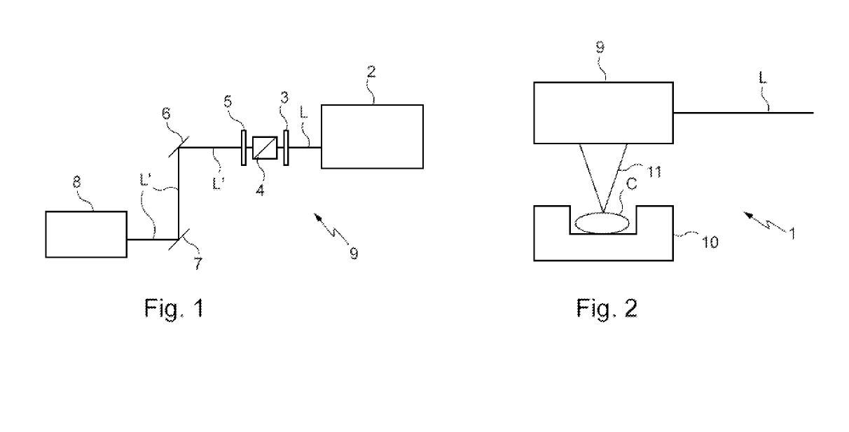

FIG. 1 schematically represents an optical system 9 forming part of a laser marking device 1 according to the invention. The optical system 9 consists of the parts 2, 3, 4, 5, 6, 7 and 8.

A laser ray source 2 emits a laser ray L which passes through the optical system 9. Thus, the laser ray L passes through a λ/2 plate or a half-wave plate, 3, creating a 180° phase shift, that is to say, a delay of a half wavelength, then a polarizing cube 4 to modify the pulse energy, and a λ/4 plate or quarter-wave plate, 5, making it possible to have a circular polarization that is necessary to a good uniformity of the ablation on the two axes of the laser scan.

The duly obtained laser ray L′ is guided by two mirrors, namely a mirror 6 at 45° C. then a mirror 7 at 45° C., to a laser focusing part 8 provided with a focusing lens (not represented) making it possible to target and concentrate the laser ray on the focal point.

FIG. 2 illustrates the device 1 for marking the tablet C of FIG. 1. The device 1 comprises the optical system 9, and makes it possible to mark a tablet C by means of a laser ray 11, targeted and entered, which is focused on the surface of the tablet C. As indicated above, the optical system 9 comprises the source, the optical elements and the focusing elements of the laser.

The tablet C is present in a cavity 10 of cylindrical form used to position the tablet C within the field of the laser. The cavity 10 belongs to a tool made of aluminum (not represented) including cavities, for example 14 cavities, all identical with a diameter of 9.5 mm and depth of 6 mm. This tool can be hermetically sealed for transportation with a transparent plastic cover.

The relative movement of the surface of the tablet and of the laser ray is here obtained by means for displacing the tablet linked to the tool. Generally, the control and the detection of these displacements are linked to a control device, for example managed by software, which also analyses the parameters of the laser source.

The following examples illustrate the invention without in any way limiting the scope thereof.

### EXAMPLES

The device 1 according to the invention has been used to mark different tablets. The verification of the marking pattern, which comprises two closed continuous grooves alongside one another, was done by optical microscopy. In a few cases, the marking pattern was characterized by scanning electron microscopy (SEM). Thus, photos of the particles were taken during the tests, and correspond to ×20 and ×100 enlargements for the optical microscope.

Tests were carried out using the marking device 1 according to the invention on different tablets, namely:

a dark pink film-coated tablet: tablet C1, with dimensions L×w×h of 15.6×8.1×4.9 mm, Rz of 11 μm, and hardness between 100 and 160 N;

a light pink, uncoated oblong tablet: tablet C2, of dimensions L×w×h of 15.5×8.0×4.8 mm, Rz of 15 μm, and hardness between 100 and 160 N;

a white uncoated oblong tablet: tablet C3, with dimensions L×w×h of 12.4×6.4×3.6 mm, Rz of 15 μm, and hardness between 80 and 120 N.

The tests carried out consisted in marking the tablets by setting the values of a number of parameters which are: the focal length of the focusing lens F (which corresponds to the diameter of the lens used), the pulse energy E (linked to the power P and to the firing rate v), the scanning speed (speed of displacement of the beam on the laser), and the wavelength A. All these parameter settings of the laser ray can be summarized in a single parameter which is the energy per surface area. In all cases, the aim of these marking tests was to obtain, for each tablet, an anti-counterfeiting marking that is invisible to the naked eye, not perceptible to the touch and visible to the microscope. The results of the different tests are summarized hereinbelow.

Three different laser ray sources were used according to these examples:
S-Pulse HP² laser (Amplitude Systems), called laser I,
S-Pulse laser (Amplitude Systems), called laser II, and
quadrupled Vanadate laser, called laser III.

The characteristics of these lasers are given below:

| Laser I: | | |
|---|---|---|
| Wavelength (λ): | 1030 | nm |
| Pulse duration: | 500 | fs |
| Pulse energy used: | 1-100 | μJ |
| Lenses used: | f-theta 100 mm and 60 mm | |
| Laser II: | | |
| Wavelength (λ): | 1030 | nm |
| Pulse duration: | 500 | fs |
| Pulse energy used: | 3.75-22.5 | μJ |
| Lenses used: | 50 | mm |
| Laser III: | | |
| Wavelength (λ): | 266 | nm |
| Pulse duration: | 25 | ns |
| Pulse energy used: | 3-6 | μJ |

| | |
|---|---|
| Lenses used: | f-theta 50 mm lens; Afocal x3 |

### Example 1

### Dark Pink Film-Coated Tablet (C1)

### Example 1A

A first test of marking of a tablet C1 was carried out with the laser I and a focal length 60 mm. The laser ray was emitted at a rate of 100 kHz for a pulse energy of 100 nJ. The speed of scanning of the surface of C1 was 2000 mm/s. The energy per surface area was 1 mJ/mm².

This test was performed on a pattern comprising two closed grooves separated from one another, a groove of elliptical type and a groove of roughly elliptical type. The shortest distance between these two grooves was approximately 10 μm.

The pattern had a size of 100×90 μm. This pattern was invisible to the naked eye. By optical microscopy with an enlargement of 100, it was possible to see this pattern.

The film coating had a thickness of 50 μm. After removal of the film coating after the test, by cutting the tablet using a microtome which made it possible to make the film coating fall away, it was possible to confirm by scanning electron microscopy the integrity of the tablet and to check that the groove produced by laser marking had not passed through the film coating layer.

### Example 1B

A second test of marking of a tablet C1 was carried out with the laser III and a focal length of 50 mm. The laser ray was emitted at a rate of 20 kHz for a pulse energy of 3000 nJ. The speed of scanning of the surface of C1 was 25 mm/s. The energy per surface area was 240 mJ/mm².

A complete pattern with a size of 190×150 μm was etched, as in the Example 1A.

This pattern was invisible to the naked eye, and perfectly visible by optical microscopy (“×100”).

### Example 2

### Light Pink Uncoated Tablet (C2)

### Example 2A

A first test of marking of a tablet C2 was carried out with the laser I and a focal length of 60 mm. The laser ray was emitted at a rate of 100 kHz for a pulse energy of 100 nJ. The speed of scanning of the surface of C1 was 200 mm/s. The energy per surface area was 5 mJ/mm².

A complete pattern with a size of 200×180 μm was etched, as in the Example 1A.

This pattern was invisible to the naked eye, and perfectly visible by optical microscopy (“×100”).

### Example 2B

A second test of marking 5 of a tablet C2 was carried out with the laser III and a focal length of 50 mm. The laser ray was emitted at a rate of 20 kHz for a pulse energy of 3000 nJ. The speed of scanning of the surface of C1 was 25 mm/s. The energy per surface area was 240 mJ/mm².

A complete pattern with a size of 190×150 μm was etched, as in the Example 1A.

The results obtained by optical microscopy (“×100”) show a visible pattern size whereas it is not visible to the naked eye. It was particularly noted that, for the laser III, the pattern was even sharper than with the laser I.

### Example 3

### Uncoated, Non-Film-Coated White Tablet (C3)

### Example 3A

A first test of marking of a tablet C3 was carried out with the laser III and a focal length of 50 mm. The laser ray was emitted at a rate of 20 kHz for a pulse energy of 3000 nJ. The speed of scanning of the surface of C1 was 50 mm/s. The energy per surface area was 120 mJ/mm².

The complete etched pattern had a size of 190×150 μm, as in the Example 1A.

The results obtained by the optical microscope with an enlargement of 100 showed a visible pattern whereas it was not visible to the naked eye.

### Example 3B

A second test of marking of a tablet C3 was carried out with the laser II and a focal length of 60 mm. The laser ray was emitted at a rate of 100 kHz for a pulse energy of 100 nJ. The speed of scanning of the surface of C1 was 200 mm/s. The energy per surface area was 2.5 mJ/mm².

The complete etched pattern had a size of 200×180 μm, as in the Example 1A.

The pattern, not visible to the naked eye, was visible in optical microscopy with an enlargement of 100, the sharpness being better in the case of the laser III than in the case of the laser II.

Finally, repeatability tests were carried out by using the laser I and a focal length of 60 mm, with 10 tablets per test, for the Examples 1A, 2A (the only difference lying in the scanning speed of 200 mm/s in the case of the repeated test), and 3A. A high degree of repeatability was observed.

In all cases, in an industrial context, the average marking time corresponds to approximately 80 ms. This average marking time generally comprises the time due to the processing of the information by the marking software and the time due to the marking itself. This could easily be optimized in the context of the invention by using software dedicated to a particular pattern or by multiplying the number of laser beams by an optical system dividing up the initial beam.

What is claimed is:

1. A marked solid pharmaceutical form comprising at least one continuous groove marking its surface, each groove being of a depth lying within a range from 20 μm to 50 μm.

2. The pharmaceutical form according to claim 1, wherein each groove has a width lying within a range from 5 μm to 120 μm.

3. The pharmaceutical form according to claim 2, wherein said range is from 10 μm to 100 μm.

4. The pharmaceutical form according to claim 1, wherein each groove forms a closed continuous line.

5. The pharmaceutical form according to claim 1, wherein each groove has a length lying within a range from 250 μm to 3 mm.

6. The pharmaceutical form according to claim 5, wherein said range is from 250 μm to 500 μm.

7. The pharmaceutical form according to claim 1, wherein the surface of the pharmaceutical form has an average roughness depth, as measured by the standard ISO 4287:1998, lying within a range from 10 μm to 40 μm.

8. The pharmaceutical form according claim 7, wherein said average roughness depth lies within a range from 20 μm to 40 μm.

9. The pharmaceutical form according to claim 1, which comprises at least two grooves each forming a closed continuous line.

10. The pharmaceutical form according to claim 1, wherein each groove is inscribed in a square with a side lying within a range from 100 μm to 250 μm.

11. The pharmaceutical form according to claim 10, wherein said range is from 200 μm to 250 μm.

12. A method for marking at least one solid pharmaceutical form according to claim 1, said method comprising forming at least one groove by ablation of the surface of the solid form by means of a laser ray, wherein the laser ablation is performed with a laser energy lying within a range from 0.1 mJ/mm² to 500 mJ/mm².

13. The method according to claim 12, wherein said laser energy range is from 0.1 mJ/mm² to 250 mJ/mm².

14. The method according to claim 12, wherein said method comprises supplying a laser ray source, supplying optical guiding means for guiding the laser ray to the surface of the form, supplying relative displacement means between the form and the laser ray, and producing a continuous groove on the surface of the form by means of laser ablation by the laser ray and by means of the relative displacement of the surface and of the laser ray.

15. The method according to claims 14, wherein the optical guiding means comprises a focusing lens, with a focal length chosen from the group consisting of 50 mm, 60 mm and 100 mm.

16. The method according to claim 14, wherein said laser ray source is an infrared laser with a pulse duration of 100 to 1000 fs, pulse energy of 0.1 μJ to 100 μJ, and a wavelength lying within a range from 1000 to 1,000,000 nanometers.

17. The method according to claim 16, wherein said pulse energy is 0.1 μJ to 30 μJ.

18. The method according to claim 16, wherein said wavelength is 1030 nm.

19. The method according to claim 14 , wherein said laser ray source is an ultraviolet laser with a pulse duration of 5 to 50 ns, pulse energy of 1 to 100 μJ, and a wavelength lying within a range from 10 to 380 nanometers.

20. The method according to claim 19, wherein said pulse energy is 3 μJ to 100 μJ.

21. The method according to claim 19, wherein said wavelength is 266 nm.

22. The method according to claim 14, wherein said optical guiding means comprises at least one means for separating the laser ray into a number of secondary rays so as to form a number of continuous grooves on the surface of the pharmaceutical form.

23. The method according to claim 22 wherein said number of secondary rays form said number of continuous grooves simultaneously.
